(19) United States
(12) Patent Application Publication
(10) Pub. No.: US 2021/0149752 A1
(43) Pub. Date: May 20, 2021

(54) Communication System

(71) Applicant: United Kingdom Atomic Energy Authority, Abingdon, Oxford (GB)

(72) Inventors: Guy Burroughes, Abingdon, Oxford (GB); Matthew Goodliffe, Abingdon, Oxford (GB); Robert Skilton, Abingdon, Oxford (GB)

(21) Appl. No.: 16/626,377

(22) PCT Filed: Jun. 25, 2018
(86) PCT No.: PCT/GB2018/051766

§ 371 Date: Dec. 24, 2019

(30) Foreign Application Priority Data
Jun. 26, 2017 (GB) 1710158.5

(51) Int. Cl. G06F 9/54; G06F 16/25; G06F 16/245

(52) U.S. Cl. CPC G06F 9/547; G06F 16/252; G06F 16/245; G06F 16/258

(57) ABSTRACT

1. A computer-implemented method of allowing a first application and a second application to communicate within a publish/subscribe architecture, the first and second applications each being aware of a structure of a database definition topic, the method comprising: 1) providing two topics to which the applications can subscribe, the database definition topic and a database topic; 2) structuring the database definition topic such that data held therewithin defines the structure of data within the database topic; 3) causing the first application to publish a definition entry in the database definition topic, the definition entry including a data format definition and a data location, and at least one data entry to the database topic, the entry to the database topic having the defined data format and being placed at the defined location; 4) causing the second application to query the database definition topic to obtain the defined format and location of data sought within the database topic; 5) causing the second application to query the database topic to obtain the sought data as specified within the definition entry of the database definition topic; and 6) causing the second application to interpret the sought data using the data format definition.

This invention relates to a communication system for a network of devices running applications thereon. More particularly, the invention relates to a distributed database and the use of virtual proxies to facilitate control of remote devices/applications. The invention may have particular application for networked robots and/or the Internet of Things (IoT), for example in managing and controlling automated or partially-automated systems, but it need not be limited to these uses.

In prior art software architecture, “publish/subscribe”, such as in US2008/0256553, is a messaging pattern where senders of messages, called publishers, do not program the messages to be sent directly to specific receivers, called subscribers, but instead characterise published messages into topics without knowledge of whether any subscribers exist. Similarly, subscribers express interest in one or more topics and only receive messages that are of interest, without knowledge of which publishers, if any, there are.

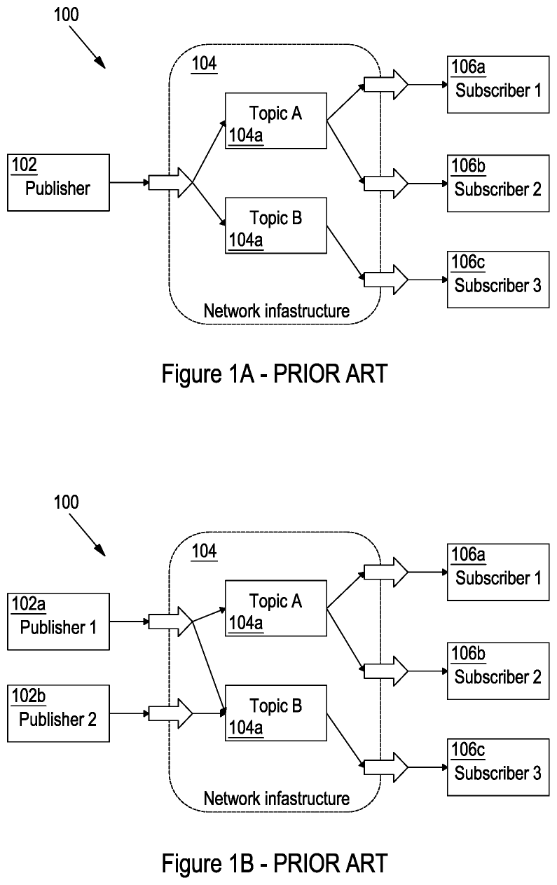

In a topic-based system 100, as shown in FIGS. 1A and 1B, messages are published to “topics” or named logical channels. Subscribers 106 (106a, 106b, 106c) in a topic-based system receive all messages published to the topics 104a, 104b to which they subscribe, and all subscribers to a topic receive the same messages. The publisher 102 (or publishers 102a, 102b) is responsible for defining the topics to which subscribers 106 can subscribe.

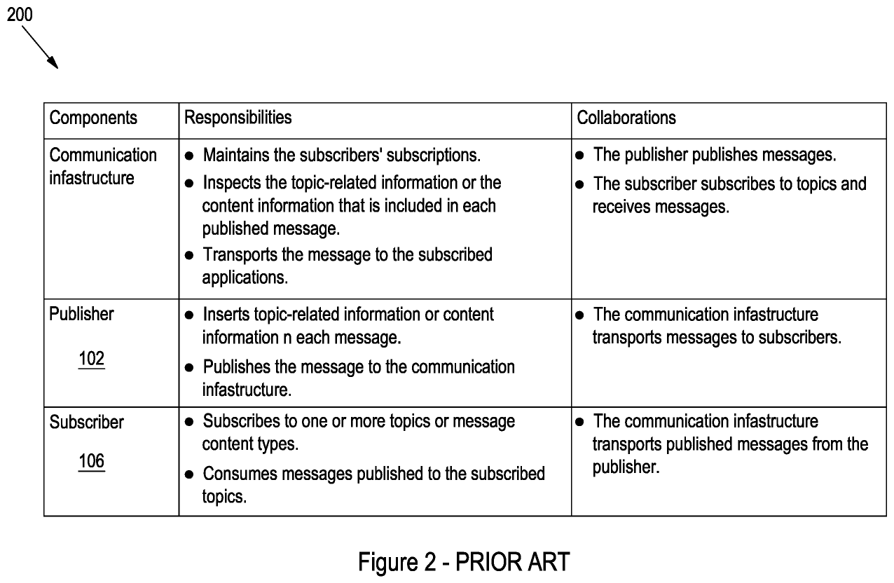

The table 200 in FIG. 2 illustrates the role and responsibilities of the different entities within the publish/subscribe model of communications.

One of the main advantages of the publish/subscribe model of communications is that publishers 102 are only loosely coupled to subscribers 106, and need not even know of their existence. With the topic being the focus, publishers and subscribers can remain ignorant of system 100 topology. Each can continue to operate normally regardless of the other. In the traditional tightly coupled client-server paradigm, the client cannot post messages to the server while the server process is not running, nor can the server receive messages unless the client is running.

Furthermore, the publish/subscribe model of communications provides the opportunity for better scalability than the traditional client-server model, through parallel operation, message caching, tree-based or network-based routing, etc. However, in certain types of tightly coupled, high-volume enterprise environments, as systems scale up to become data centres with thousands of servers sharing the publish/subscribe infrastructure, current systems often lose this benefit.

Outside of the enterprise environment, on the other hand, the publisher/subscriber paradigm has proven its scalability to volumes far beyond those of a single data centre, providing Internet-wide distributed messaging through web syndication protocols.

The structure of the published data must be well defined, and quickly becomes inflexible. In order to modify the published data structure, it would be necessary to know about all the subscribers, and either modify them also to accept the new structure, or maintain compatibility with older versions. This makes refactoring of publisher code difficult. Since requirements change over time, the inflexibility of the data structure becomes a burden on the programmer. This is a common issue with any prior art client/server or publish/subscribe architecture and makes it hard to keep systems up to date as technology changes. For example, the high degree of semantic heterogeneity of events in large and open deployments such as smart cities and the sensor web makes it difficult to develop and maintain publish/subscribe systems.

Further, in the prior art, communication internally and externally to a program are different. External (remote) communications are generally more complicated and cumbersome than their internal counterparts. Moreover, it generally requires a lot of networking that all must be maintained by an application developer.

The skilled person will appreciate that the alternative approach to handling remote communications may be applied in a system also using the alternative approach to tackling the issue of semantic matching, or separately, and vice versa.

According to a first aspect of the invention, there is provided a method of allowing a first application and a second application to communicate within a publish/subscribe architecture. Typically, the first and second applications are each aware of a structure of a database definition topic. Conveniently, the method comprises at least one of the following steps:
1) providing two topics to which the applications can subscribe, the database definition topic and a database topic;
2) structuring the database definition topic such that data held therewithin defines the structure of data within the database topic;
3) causing the first application to publish a definition entry in the database definition topic. Here, the definition entry may include one or more of the following: a data format definition, a data location, and at least one data entry to the database topic. The entry to the database topic should conveniently have the defined data format and be placed at the defined location;
4) causing the second application to query the database definition topic to obtain the defined format and location of data sought within the database topic;
5) causing the second application to query the database topic to obtain the sought data as specified within the definition entry of the database definition topic; and
6) causing the second application to interpret the sought data using the data format definition.

An advantage of such a method is that it keeps the loose coupling within space, time and synchronisation providing a scalable infrastructure for information exchange and distributed workflows, whilst ameliorating the problems relating to tight coupling, via event subscriptions and patterns, to the semantics of the underlying schema and values. As such, a method, and underlying system, is provided that is easier for a programmer to maintain saving both time and effort. Thus, the network that is effectively provided by the connection of the first and second applications may be thought of as being an improved network in which technical problems have been overcome.

The first and second applications may communicate via the network.

The first application may be installed on a first device, and the second application may be installed on a second device. The first and second devices may communicate via the network, by means of the applications' subscriptions to the two topics.

The second device may be remote from the first device, and/or there may be no wired connection therebetween.

The location conveniently comprises an identification of the first application as the publisher of the corresponding entry to the database topic.

Further, the location may comprise a unique identifier present in both the data definition topic entry and the corresponding database topic entry. The unique identifier may be arranged to allow the corresponding database topic entry to be uniquely identified.

The method may be arranged to allow multiple publishers, including the first application, to publish data to the two topics. Further the method may allow multiple subscribers, including the second application, to obtain data from the two topics.

Here, it is convenient if each publisher and subscriber is aware of the structure of the database definition topic.

Conveniently, the method allows at least one of the first application and the second application to be both a publisher and a subscriber.

The method may be arranged to use brokers. Conveniently, a broker will perform at least one of the following:
receive information that a publisher intends to publish to the database topic;
store information regarding the publishers;
receive a database definition topic query from the second application;
direct a second application to the publishers so that the second application can receive the database definition topic entries from the publishers and identify the location of the sought data, the location identifying the corresponding publisher which in this case is the first application;
receive the database topic query from a second application, the database topic query including the identified location; and
direct a second application to a first application, so that that second application can obtain the sought data.

The database definition topic entry may comprise semantic information relating to the corresponding database topic entry. Further, the database definition topic may be searchable based on the semantic information.

In some embodiments, more than one database topic is provided. The data location may comprises an identification of the database topic containing the corresponding data entry.

Conveniently, at least one of the topics is divided into multiple sub-topics, which may be hierarchical.

Conveniently, the database definition topic structure comprises a table, or other data field format, with a constant and defined number of columns, constant and defined column headings, and a constant and defined data format for each column.

According to a second aspect of the invention there is provided a method of providing searchable data to a database, which may be a distributed database, within a publish/subscribe architecture. Conveniently, the method comprises at least one of the following step:
1) publishing a data definition entry to a database definition topic having a known structure, the data definition entry comprising a data format definition;
2) assigning an identifier to the data definition entry;
3) assigning the same identifier to an entry of a database topic, the database topic being separate from the database definition topic; and
4) publishing data to the identified row of the database topic, the data having the defined data format.

Embodiments according to the second aspect of the invention are advantageous as they provide the functionality of a publisher within the method of the first aspect of the invention.

According to a third aspect of the invention there is provided a method of retrieving data from a database, which may be distributed, within a publish/subscribe architecture. Conveniently, the method comprises at least one of the following steps:
1) searching a database definition topic having a known structure to find a data definition entry corresponding to the sought data, the data definition entry comprising a data format definition and data location identifier of the sought data;
2) searching a database topic to find data corresponding to the data location identifier; and
3) interpreting the data according to the data format definition.

Embodiments according to the third aspect of the invention are advantageous as they provide the functionality of a subscriber within the method of the first aspect of the invention.

At least one of the database topic and the database definition topic may be distributed.

In some embodiments, both topics are distributed.

According to a fourth aspect of the invention there is provided a system to provide the first aspect of the invention.

According to a fifth aspect of the invention there is provided a system to provide the second aspect of the invention.

According to a sixth aspect of the invention there is provided a system to provide the third aspect of the invention.

According to a seventh aspect of the invention there is provided a machine readable data carrier which contains instructions to provide the method or system of any of the preceding aspects of the invention.

According to an eighth aspect of the invention there is provided a method of operating a remote application. Conveniently, the method comprises at least one of the following steps:
1) communicating with the remote application across a connection thereto;
2) receiving information from the remote application across the connection,
3) creating, in a local processing circuitry running a local application, a proxy of at least a portion of that remote application using the received information, wherein the proxy is a simulated version of the at least a portion of the remote application comprising a local copy of data stored by the portion of the remote application and may be also a proxy of functions corresponding to callable functions of the portion of the remote application;
4) causing the proxy to communicate with the remote application so as to keep the local copy of the data held by the portion of the remote application up to date, such that the local application can make a local memory call to obtain that data; and
5) causing the proxy to relay any local calls on the proxy functions made by the local application to the corresponding callable function of the portion of the remote application,
wherein the proxy is arranged to handle remote communications between the local processing circuitry and the remote application such that the local application can interact with the portion of the remote application using local communication.

The creation of the proxy may be performed automatically, without requiring any user input.

Embodiments providing the eighth aspect of the invention are advantageous because they simplify the complex task of devices communicating across a network by hiding much of the network communication.

Conveniently, the proxy is arranged to be a copy of the remote application that it simulates and this may be thought of as being a copy of the entire remote application. In some embodiments, the proxy is arranged to be a copy of a remote sensor, however, that sensor may be provided with an application arranged to communicate.

The proxy may be arranged to provide two-way communications between the remote application and the local application.

In some embodiments, the proxy is arranged to include portions of different applications to provide a proxy which is an aggregate of the two or more applications that it models.

Indeed, the applications that are being modelled by the proxy may be on different processing circuitries, thereby providing a method of creating virtual devices that do not exist as single entities outside of the proxy.

The method of the eighth aspect may be arranged to use the publish/subscribe architecture of any of the first seven aspects of the invention.

According to a ninth aspect of the invention there is provided a system comprising at least one processor arranged to provide the method of the eighth of the invention.

According to a tenth aspect of the invention there is provided a machine readable data carrier carrying instructions which when read by a processor cause that processor to perform the method of method of the eighth aspect of the invention.

According to an eleventh aspect of the invention there is provided a machine readable data carrier carrying instructions which when read by a processor cause that processor to perform as the processor of the ninth aspect of the invention.

The skilled person will appreciate that features discussed in relation to any one aspect of the invention may be provided with any other aspect of the invention with suitable modifications which will be apparent to the person skilled in the art.

The machine readable medium referred to in any of the above aspects of the invention may be any of the following: a CDROM; a DVD ROM/RAM (including -R/-RW or +R/+RW); a hard drive; a memory (including a USB drive; an SD card; a compact flash card or the like); a transmitted signal (including an Internet download, ftp file transfer of the like); a wire; etc.

Embodiments of the invention will now be described in more detail by way of example only with reference to the accompanying drawings in which like reference numerals are used for like features:

FIG. 1A (prior art) is a schematic view of a traditional publish/subscribe communication model;

FIG. 1B (prior art) is a schematic view of the traditional publish/subscribe communication model shown in FIG. 1A;

FIG. 2 shows the responsibilities and roles of components of the traditional publish/subscribe communication model shown in FIGS. 1A and 1B;

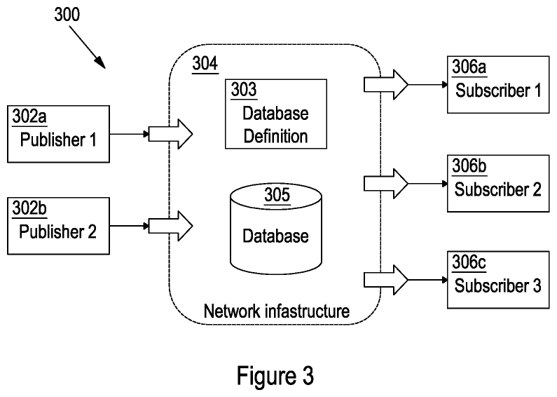

FIG. 3 is a schematic view of a distributed database communication model in line with various embodiments of the invention;

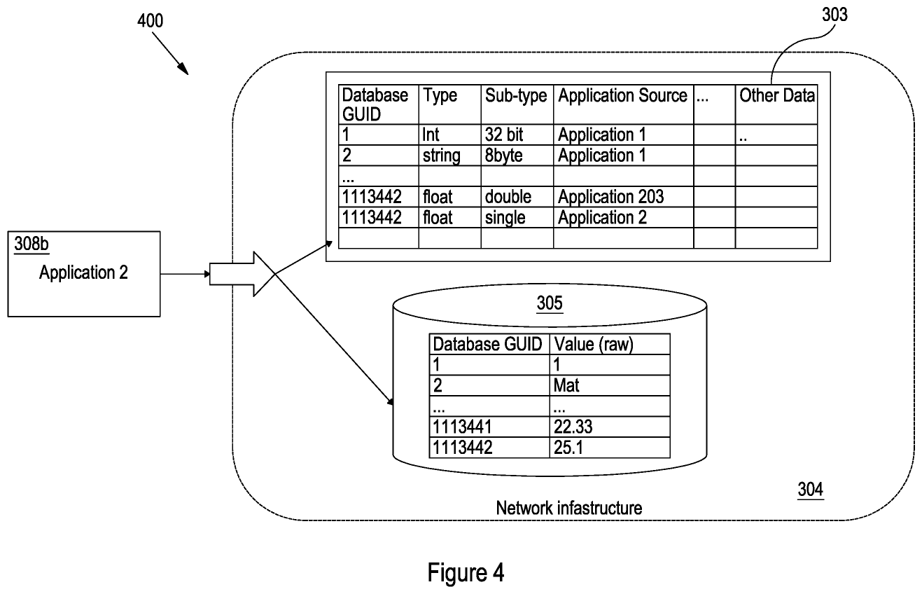

FIG. 4 illustrates use of the distributed database communication model shown in FIG. 3;

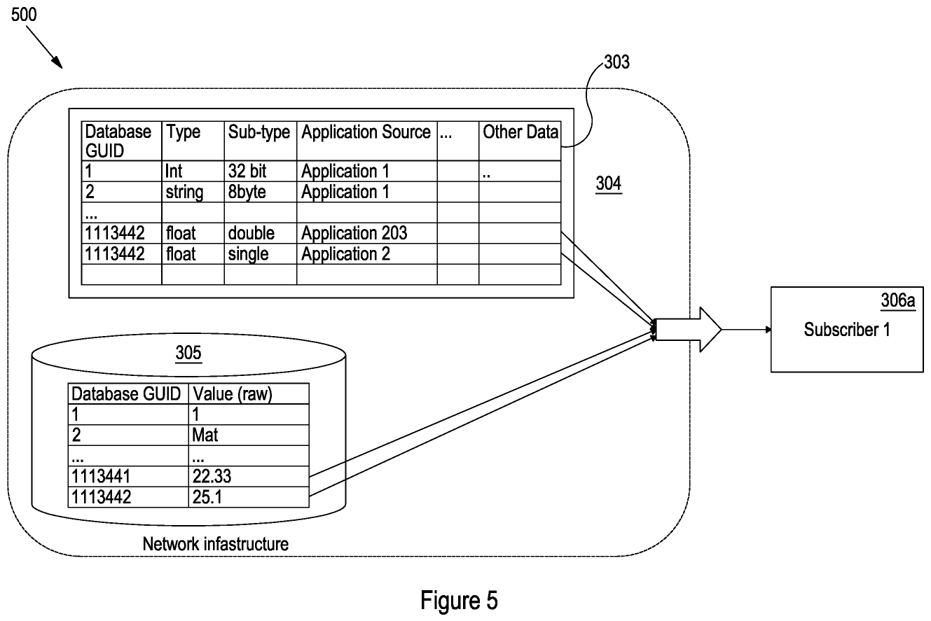

FIG. 5 illustrates querying of the distributed database communication model shown in FIGS. 3 and 4;

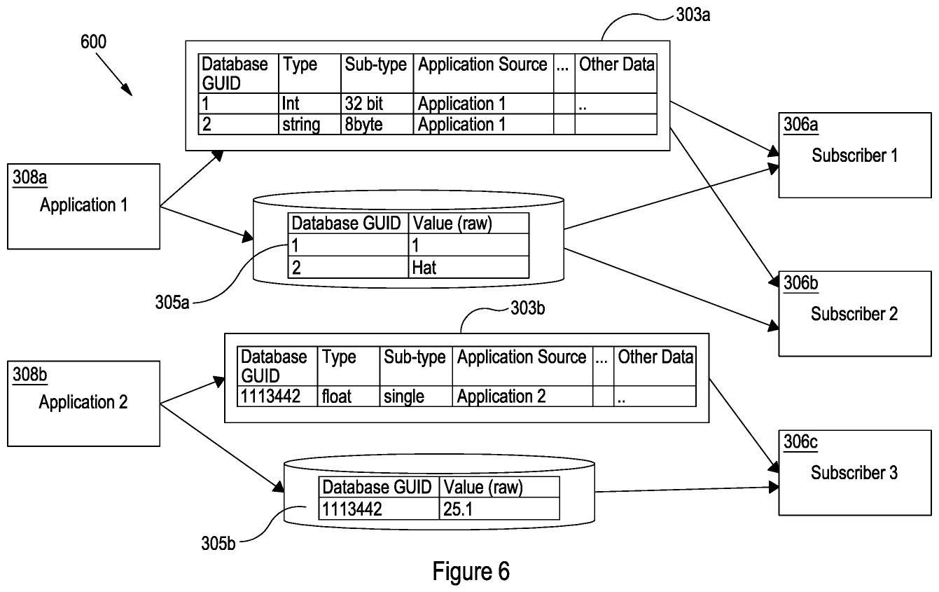

FIG. 6 illustrates use of the distributed database communication model shown in FIGS. 3 to 5;

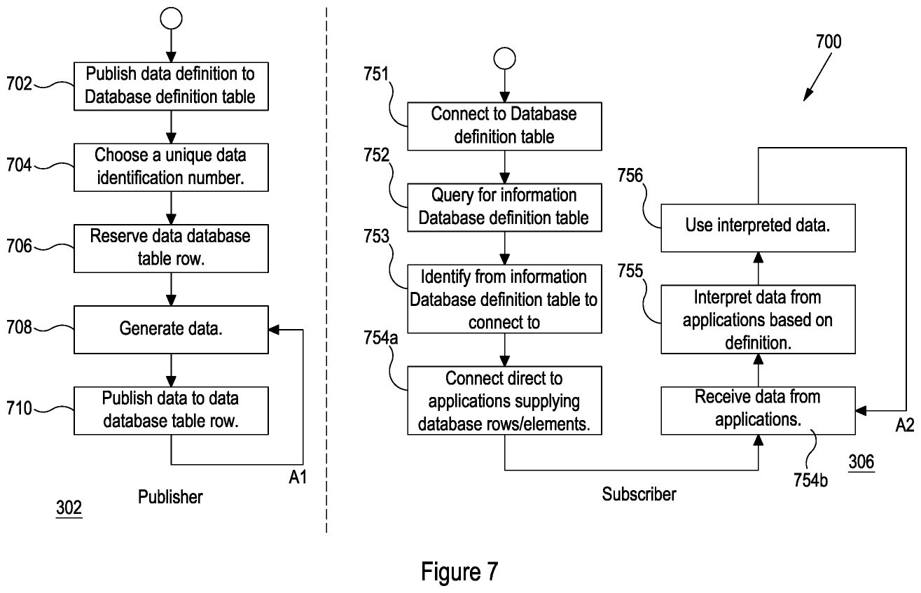

FIG. 7 shows the responsibilities and roles of components of the distributed database communication model shown in FIGS. 3 to 6;

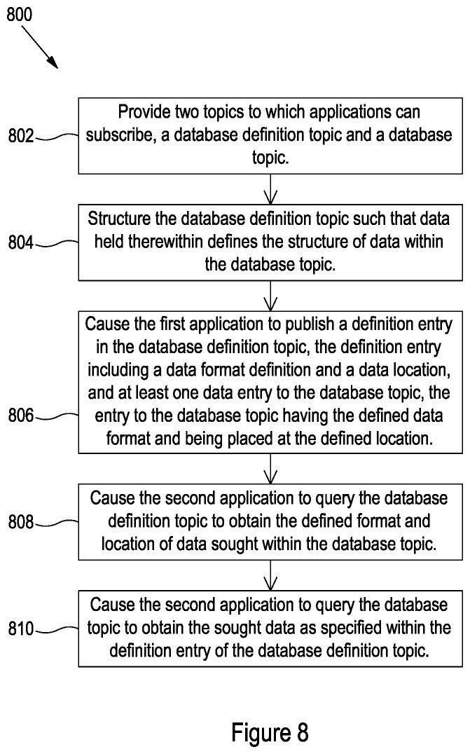

FIG. 8 is a flow chart of a method of distributed database communication in line with various embodiments of the invention;

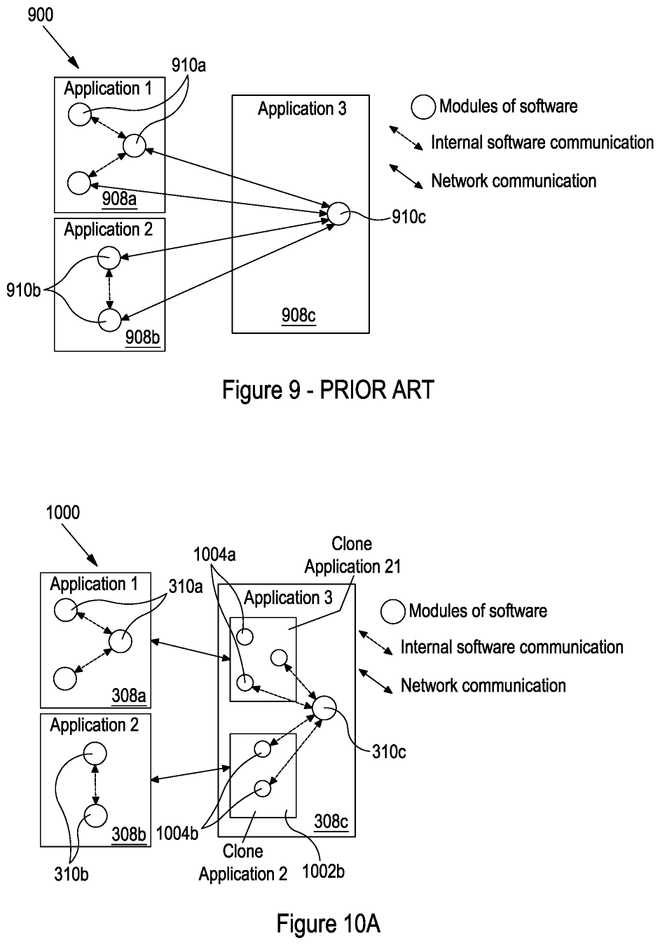

FIG. 9 (prior art) illustrates traditional communication models for communications between remote applications;

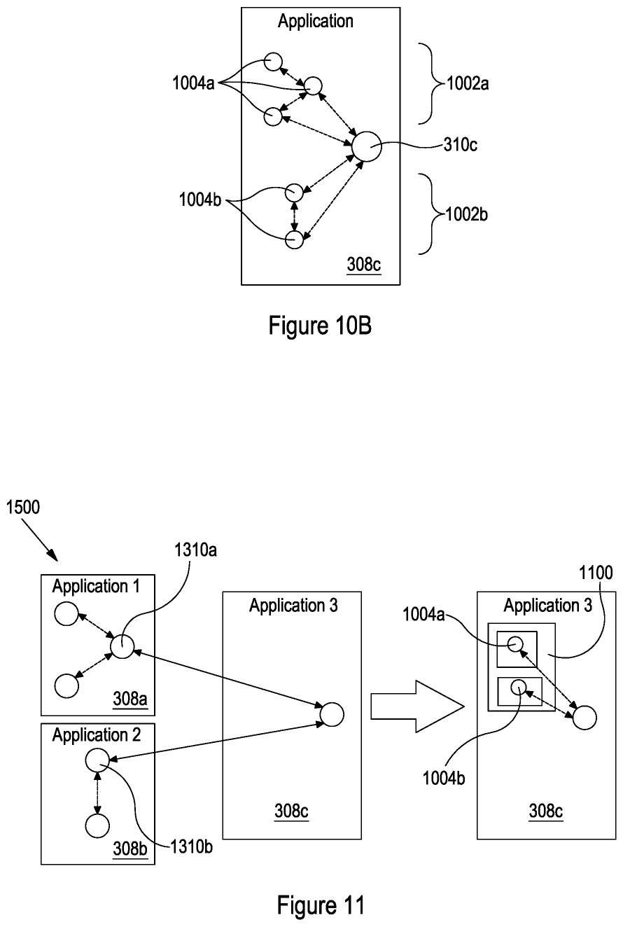

FIG. 10A shows a virtual proxy communication model in line with various embodiments of the invention;

FIG. 10B illustrates how the virtual proxy communication model of FIG. 10A effectively disguises the remoteness of software objects;

FIG. 11 illustrates an alternative embodiment of the virtual proxy communication model shown in FIGS. 10A and 10B;

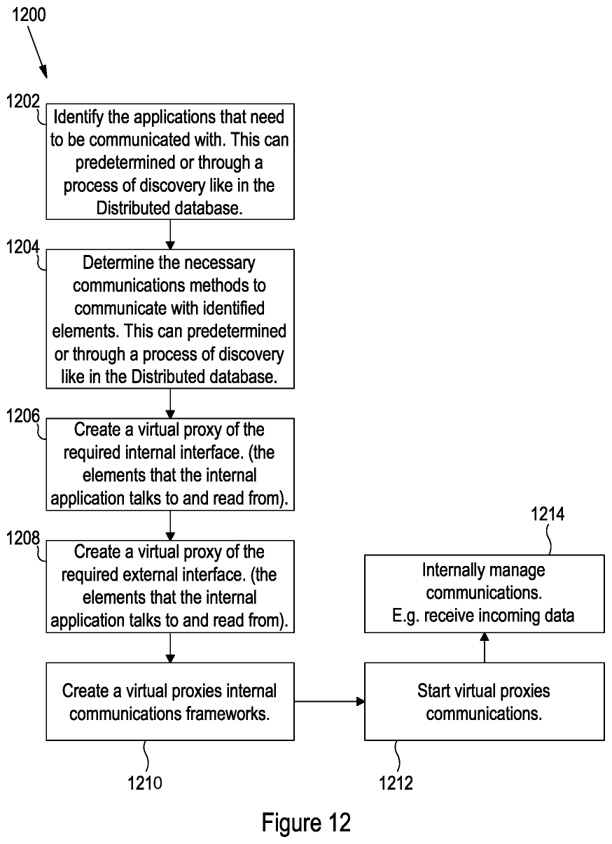

FIG. 12 is a flow chart of a method of communication using one or more virtual proxies in line with various embodiments of the invention;

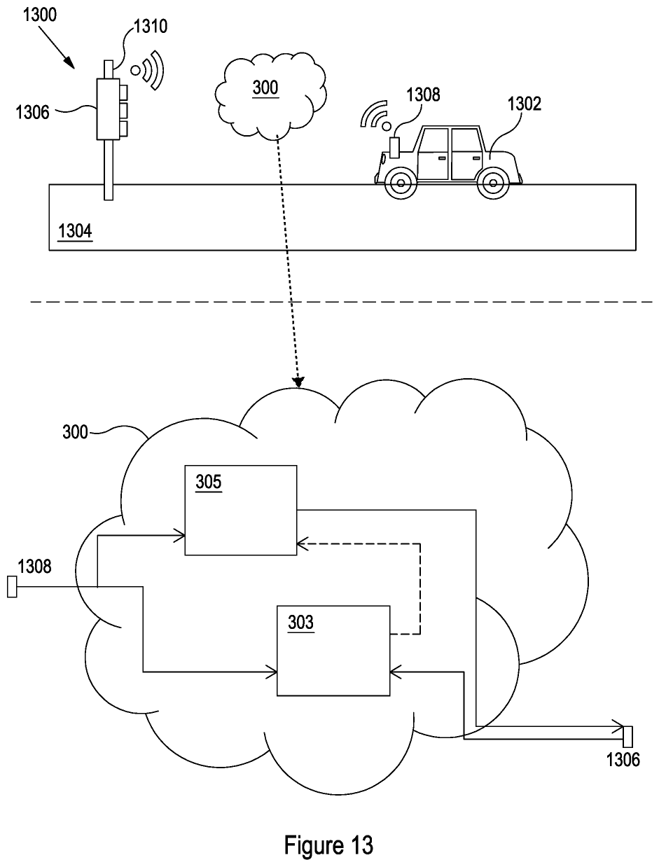

FIG. 13 illustrates the use of the technology disclosed herein in a street scene; and

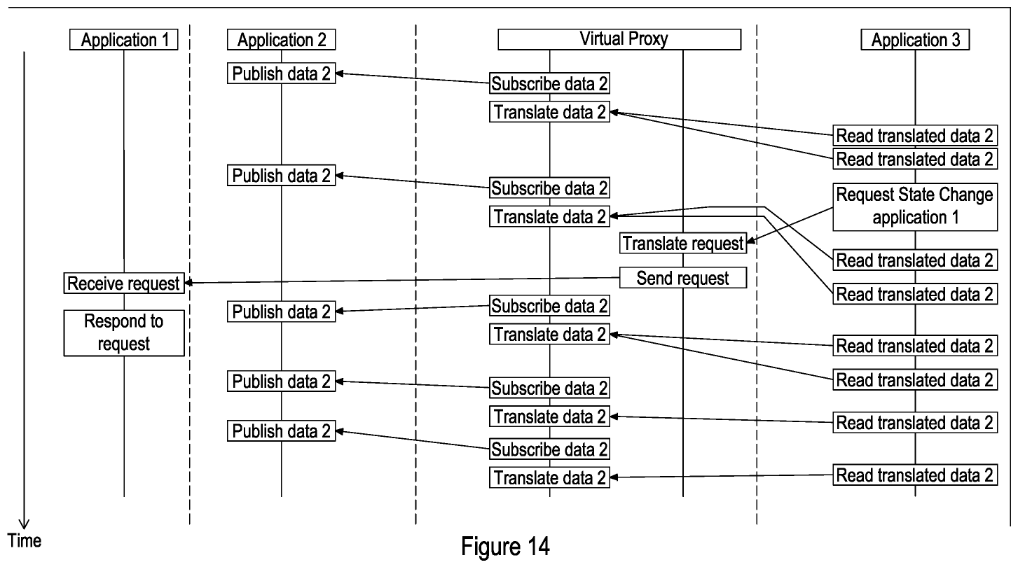

FIG. 14 is a communication diagram showing communication flow between applications and virtual proxies.

In the drawings, like and corresponding reference numerals are used for like and corresponding components, respectively.

In the following, reference is made to applications. This term is used as shorthand to exemplify an entity with a predetermined/defined functionality. That application is typically comprised of a series of instructions (ie a program) which is run by a processing circuitry, conveniently provided by a processor together with support circuitry.

Commonly the processing circuitry is a computer such as an X86 architecture system, with an Intel, or an AMD, or the like processor communicating across a system bus with memory (often both volatile and non-volatile).

However, the processing circuitry can of course be provided by any device suitable to run an application capable of performing the methods of the embodiments. For example, the processing circuitry may be a ‘phone (for example, an iPhone, an Android phone, a Windows mobile phone, or the like), a tablet (such as an iPad, an Android tablet, a Kindle, or the like), a watch (such as an iWatch), a television, any Internet of Things (IoT) capable device, a robot, a self-driving vehicle, etc.

In many embodiments, applications running on the devices will actually be arranged to control the device.

Embodiments will typically rely on network communication between applications running on different processing circuits. The skilled person will appreciate the disparate nature of networks per se and appreciate that the network man simply be viewed as a transport mechanism. As such, mention of network is intended to cover any suitable network. Indeed a network connection may bridge a plurality of technologies. Thus, as an example, a network may include one or more of the following: Internet (including http and https); WIFI (ie IEEE 802.11xx, where xx can be any of the possible variants), GSM (Global System for Mobile communications); GPRS (General Packet Radio Service); UMTS (Universal Mobile Telecommunications System); LTE (Long Term Evolution); Ethernet; or the like.

In the approach to handling semantic coupling disclosed herein, rather than connecting to individual tightly coupled topics 104a, 104b of information (FIG. 1B), a distributed database communication model 300 is utilised. The distributed database communication model 300 (shown in FIG. 3) builds upon the publish/subscribe model 100 (FIG. 1B), but removes the previously-described issues of being tightly coupled to the semantics and formats.

In the embodiment being described with respect to FIG. 3, the data in the system 300 is placed in to two “topics” 304: the Database definition topic 303, and the Database topic 305:
The Database Definition topic 303—This creates a static definition of the data to be published in the database. The definition is static in that the structure of the database definition topic 303 is constant, even if entries are added and/or removed.
The data in the database definition topic 303 includes semantic information about the information to be included in the database topic 305. In particular, it includes the information required to connect and interpret an element of the Database topic 305, and searchable information to allow that information to be found.
In the embodiment being described, the publisher 302 (or publishers 302a, 302b) persistently serve this data.
The Database topic 305—The data is stored as rows in the database topic 305 with identifiers, which match elements in the Database Definition topic 303. In the embodiment being described, unique identification numbers (ie a unique identifier) are used, although the skilled person will appreciate that alternative identifiers may be used in additional or alternative embodiments.
In the embodiment being described, the data can be placed into, and read out of, the database topic 305 at any rate. As described hereinafter, in the embodiment being described, the data base definition topic 303 defines the correct rate at which that particular data is generated.

Both topics 303, 305 have predefined, unchanging definitions. Applications 302, 306, 308 arranged to use the system 300 arranged to connect to the topics 304 are aware of these definitions. This allows systems/applications 302, 306, 308 to communicate without pre-knowledge of each other, instead simply having knowledge of the definitions of the topics 304.

These topics 304 are therefore not split by subject matter, as for the topics 104 of the prior art system 100, but rather by function in the structure of the distributed database communication model 300.

An example of the data fields that may be provided within the database definition topic are as follows in table 1. For ease, these data fields are shown in columns within a table format, but other data structures are equally possible. Indeed, other embodiments are likely to have different data fields to those described here. There may be more fields, or less fields. Moreover, the order of fields may be varied from that shown. It is currently envisaged that on current infrastructure, a typical embodiment, there may be roughly 10 to 15 data field. However, other embodiments may have more, 20, 30, 40, 50 or more.

TABLE 1

| | | | | | | | | | |
|---|---|---|---|---|---|---|---|---|---|
| | Lo- | | Sub-t | | Geo- | | Trans. | Do- | Sub- |
| ID | cation | Type | ype | Rate | location | Desc. | location | man | domain |

Thus, it will be seen that the first column provides an Identity Number (ID) which can be used as a unique key to identify data within both the data definition topic 303 and the database topic 305.

Next, a Location field is shown, which contains address information allowing applications/processing circuits to be accessed across connections to them.

Next, in this example, is provided a data type field. This field exemplifies in the schema what information a publisher will be providing within this field in the data that publisher is publishing. For example, this may specify, amongst others, integer; float, long float, array, image, movie, or the like.

Following on from the type field, there is a sub-type field. Should such a field be used it may provide further information on the preceding type field. For example, in the example field with a data content image, the sub-field may further specify the format (eg jpeg, tiff, gif, png, or the like) and/or a resolution, etc.

Following definition fields for the type and sub-type is exemplified a rate field. In the embodiment being described this indicates the frequency at which the publisher will update the information that it is publishing. For example, this field may contain a rate of 1 kHz, indicating that new data is available at roughly each milli-second.

The Geo-location field stores a physical location of the application and/or the device on which the application is running. The Location field may be provided as a GPS co-ordinate, a grid reference co-ordinate, a street address, or any other suitable means.

Next, a Translator Location field is shown. Such a field may contain a pointer to a location, such as a network location, where an application is located that can translate data in the ‘type’ field. Such a translator will find utility for subscribers that do not have the capability to process data in the format provided in that type, but nonetheless need to access the data. In such an example, the use of a translator finds utility to allow that to occur.

The domain data field that follows contains information about the address of the publisher so that subscribers wanting to access the information published by the publisher have the ability to do so.

Further the sub-domain field provides further information about the address.

Embodiments may have more than one of any of the data fields described above. Other embodiments may also have other data fields not described here. The skilled person will appreciate that the data fields shown in table 1 are to aid understanding only and are examples of fields that may be present.

As a result, embodiments may be thought of as providing a self-describing data stream. This self-describing data stream, can provide the benefits of the publish/subscribe model, including the publishers 302 being agnostic of the subscribers 306 (and vice-versa); and the other middleware benefits known in the art. Additionally, the self-describing nature of embodiments are advantageous because they remove the tight coupling and inflexible message definitions which should improve ease of use between a wide variety of different systems/applications 302, 306, 308, and hence also makes the system 300 more future-proof than prior art systems.

The skilled person will appreciate that this combination of distributed, publish/subscribe-like communications (source-sink agnostic) with a generically query-able data structure (database-like) should find utility in a diverse range of applications, such as the Internet of Things and robotics.

In the embodiment being described, applications, running on a processing device, can query the database definition topic 303 in a similar manner to a database is queried to discover data.

As shown in FIG. 5, the database definition topic 303 provides a data identifier for the sought data and metadata about the sought data such that the application making the query—here Subscriber 1 306a—know how to interpret the sought data once it is found. That is, the metadata provides information as to the format of the data to be found in the database topic 305; for example, it might specified that the data associated with a given identifier comprises a floating point number, followed by an integer, followed by a JPEG image. As such, the application, when querying the database topic 305 knows to expect, for that identifier, a floating point number, followed by an integer, followed by a JPEG image. It is likely that other identifiers will have different metadata associated with them.

Thus, in the example being given, the identifier directs the Subscriber 1 306a to the correct part of the database topic 305 where the value(s) for the sought data can be found.

In the embodiment being described, the individual database rows of the database topic 305 are grouped into separate sub-topics 305a, 305b. This may allow them to be searched and/or published separately at different rates, so reducing overheads.

In embodiments without sub-division of the database 305, everything in the database topic 305 would be connected to and searched.

The database definition topic 303 may provide a pointer to a particular database sub-topic 305a, 305b rather than just to a database topic 305, so reducing the amount of data to be searched.

The subscribers 306 can decide what they want to connect to, based on semantic data, and are able to interpret the data, using the database definition topic 303.

The Database Definition topic 303 can also be separated into sub-database definition topics 303a, 303b, as illustrated in FIG. 6.

In such embodiments, each topic in the hierarchy of sub-database definition topics 303a, 303b exposes more information for some database row. Each of the sub-database definition topics 303a, 303b contains a subset of the total database definitions. In various such embodiments, the highest level (top) topic database definition topic holds may hold reduced semantic information. For example, the reduced semantic information may simply comprise a database identifier (e.g. an identification number), the topic being provided in the sub-databases for database definitions. As such, the database definition topic is broken into a plurality of sub-topics, which can have the advantage of reducing the overall network burden and communication overhead, since publishers may be only need to access some of the sub-topics to obtain the information that they seek.

Allowing for top level metadata to be searched, and starting to dig down to more detailed metadata by searching only appropriate sub-tables topics 303a, 303b as identified in the top level table can reduce the total amount of data to be searched, so improving efficiency.

In the embodiment being described, the sub-database definition topics 303a, 303b share the same original table column definitions so as to allow any application 302, 306, 308 knowing that format to use the database definition topic 303. In alternative or additional embodiments, the top-level database definition topic 303 may provide data format information to allow the sub-database definition topics 303a, 303b to be read.

This Database definition separation helps improve communication overheads in the network over which the communication method is being run, providing an improved network.

In alternative or additional embodiments (not shown), multiple different database topics 305 are present and connected to in the exact same manner, with a single database definition topic 303 directing users to the correct database topics 305, and optionally to the correct sub-topics 305a, 305b of that database.

Additionally, the one or more database definition topic 303 can be setup to perform remote procedure calls. In such embodiments, the database definition topic 303 can define the available remote procedure calls that an application 302, 306, 308 can call by placing a corresponding entry into the database topic 305.

Then, the database topic 305 can be searched by applications offering the remote procedure call to see if an application has called it, and can respond to it if desired.

FIG. 7 shows a flow chart of actions 700 taken by the publisher (or publishers) 302 and by the subscriber (or subscribers) 306.

In particular, the publisher 306 publishes 702 a data definition to a database definition topic 303. This may be done in response to an event or to user input, or following an automated procedure, or the like.

In the embodiment being described, a unique identifier number is chosen and assigned 704 to the data definition topic 303 by the publisher 302. In alternative embodiments, the unique identifier may be generated and/or assigned by a different entity, such as a host of the database definition topic 303.

A row of a table in a database topic 305 is then reserved 706 by the publisher.

The skilled person will appreciate that the order of these steps may be amended—for example, a row of a table in the database topic 305 may be reserved and marked with the identifier before the definition is published 702 in the definition topic 303.

The publisher 302 then generates (or otherwise provides) 708 data for the reserved row of the database topic 305.

Finally, the generated data is published 710 to the row of the database topic 305.

In the embodiment being described, the publisher 306 is prevented from publishing 708 data to the database topic 305 until or unless there is a corresponding entry in the database definition topic 303.

As indicated by the arrow A1 on the right hand side of the publisher portion of FIG. 7, further the published data may be updated following its original publication.

The subscriber 306 performs the following actions when seeking data:

Firstly, the subscriber 306 connects 751 to a database definition topic 303.

The subscriber 306 then queries 752 the database definition topic 303 for information relating to the data sought. In the embodiment being described, the information comprises both location information and format information for the sought data. Location information may for example be the current location of the subscriber 306, or a desired location (perhaps to where the subscriber 306 is moving). Here the format information may for example comprise the data that the subscriber seeks and for example the subscriber 306 may indicate that it is a temperature in which it is interested. Thus, in this example, the subscriber is seeking the temperature at a specified location and the search of the database definition topic 303 will attempt to locate sources within the database topic that can provide the sought data.

From the information provided in the database definition topic 303, the subscriber 306 identifies 753 where to look for the sought data. In the embodiments described above, the location information comprises the identification of a database topic 305 if there is more than one database topic 305 or, optionally the identification of a database sub-topic 305a, 305b, and a unique identifier for the relevant row of the relevant database topic 305. The skilled person will appreciate that location information may take other forms in additional or alternative embodiments.

The subscriber 306 then obtains 754 the sought data, by following the location information obtained from querying the database topic 305 at the specified location.

In the embodiment being described, the obtaining 754 is performed by connecting 754a to an application which is identified as providing the one or more database rows/elements identified, and retrieving 754b the sought data from the application.

The retrieved data is then interpreted 755 using the format information identified from the database definition topic 303.

The subscriber 306 can then use 756 the interpreted data as required, which can include storing data until sufficient data are obtained for use in some embodiments.

As indicated by the arrow A2 on the right hand side of FIG. 7, the process of receiving, interpreting and using data may be repeated as desired/required.

The skilled person will understand that, irrespective of where the sought data is physically stored, the subscriber 306 can be pointed to the correct location to retrieve it by the same database definition topic 303. Within the network 300, data can be universally accessible and multiple sources (publishers) can contribute seamlessly. These advantages are shared with prior art publish/subscribe systems.

FIG. 8 summarises the overall method 800 performed within the network 300.

At step 802 two topics are provided to which applications can subscribe: a database definition topic 303 and a database topic 305. Such applications may be described generally as subscribers.

At step 804, the database definition topic 303 is structured. The skilled person will appreciate that the structure is likely to be defined before the topics are provided 802 for subscription and that the ordering of steps 802, 804 is illustrative only.

The structure is typically fixed such that the database definition topic 303 can be read by any application knowing the structure, and such that data held therewithin define the structure (in particular location and format) of data within the database topic 305.

In the embodiments being described, the structure of the database definition topic 303 comprises a table with a known number of columns, each column having a known heading and a known data format. Provided that any application in the network 300 is aware of this structure, that application can read the database definition topic 303 and can therefore learn how to find and read data in the database topic 505 by accessing the database definition topic 303.

At step 806, the first Application (Application 1, 308a) publishes a data definition entry in the database definition topic 303 and at least one data entry to the database topic 305; ie Application 1 308a is acting as a publisher. The definition entry includes a data format definition and a data location for the entry to the database topic 305 from which the specified data can be obtained. The entry to the database topic 305 has the defined data format and is stored at the defined location. A unique identifier is assigned to the data definition entry published by the first application 308a which is also used for the corresponding entry in the database topic 305.

At step 808, a second application, such as Subscriber 1 306a queries the database definition topic 303 to obtain the defined format and location of data sought within the database topic 305.

At step 810, subscriber 1 306a queries the database topic 305 to obtain the sought data as specified within the definition entry of the database definition topic 303.

In some embodiments, the topics 303, 305 can be connected to based on geographic locality or network-topology, or any other suitable data field. The connection may be managed by a broker (which may be a local or distributed broker) to determine which applications to connect to. Here, the skilled person will appreciate that a broker is used in a publish/subscribe system and is typically an application running on a processing circuitry (such as a server or the like). Such a broker mediates between the publishers (that push information) and subscribers (which want to receive information) and vice versa. Whilst it is convenient to refer to a broker, in the singular, there may be a plurality of brokers that are unaware of each other and/or the broker(s) may be distributed, similar to a peer to peer system.

The database definition topic 303 is a topic 303 that has semantic schema data (which can be thought of as metadata), and which is formatted as a database that can be queried. The data in this database definition topic 303 can be from multiple sources (i.e. from one or more publishers). An application, acting as a subscriber, can approach a broker or distributed broker and attach to the distributed database topic 303 (in some embodiments, the subscriber application may have integrated brokering abilities and no separate broker may be required). The application can then connect to, and receive information from the topic's sources, which can then be analysed/queried.

The following non-limiting embodiment is provided to aid understanding of the invention:

Three applications 308a, 308b, 308c publish to the distributed database topic 305. The following example is extensively simplified in order to explain the under lying principles of the embodiment being described. The skilled person will readily appreciate to extend the teachings to a working embodiment.

TABLE 2
Database Definition Topic - 303

| | | | | |
|---|---|---|---|---|
| | | | | Other |
| ID | Location | format | . . . | descriptors |

| | | |
|---|---|---|
| 1 | Application 1 | Integer |
| 2 | Application 1 | Floating point |
| 3 | Application 2 | Integer |
| 4 | Application 3 | Bit array |

Thus, it can be seen that the database definition topic 303 comprises a number of columns, or other arrangements of data, the contents of which provide metadata on the contents of the database data topic 305.

Although other embodiments are likely to be different, in the embodiment being described, the first, left most, column comprises an identity (ID) number. This ID provides a unique key to that row of the database definition topic 303 and also ties the data to the correct entry within the database topic 305.

The second column of data contains the identity of the application that publishes the data. In the example being given, this filed simply states Application 1, etc. In other embodiments the data is likely to take a different format and may be number, a string of characters, such as alphanumeric characters or the like.

Further, in other embodiments the location data may well additionally comprise a network address, IP address, hostname, publishername, etc

The next, third, column then specifies the first field of data that will be found at the specified location. In the first row, it will be seen that the first field of data found at the location of application 1 is an Integer.

The number of columns in an embodiment is sufficient to describe the data that is to be found at the location of the applications. As such, the number of columns should enough to specify the maximum amount of data found at any given location.

TABLE 3
Database Topic - 305

| ID | Data |
|---|---|
| 1 | 1 |
| 2 | 2.3 |
| 3 | 234294 |
| 4 | 101010001110100100101001 |

The above table, table 3, exemplifies data found in the database topic 305.

Here the first, leftmost, column is again an identity number (ID) which again provides a unique identifier to the data and corresponds to the ID provided in the network definition topic 303.

As such, it can be seen from table 2, that ID 1 is published at location ‘Application 1’ and the first field comprises an integer. As such, ID 1 in the database topic table, table 3, is an integer and in this example is the number ‘1’. Thus subscribers that determine that they want data published by Application 1 and connect to the specified location of application 1 and that subscriber knows to expect an integer value.

As a further example, it can be seen from table 3, second row, ID 2 specifies that at location ‘Application 2’ data can be found where the first field is a floating point number. Then looking at table 3 that at ID2 (ie the location of Application 2—and as detailed in the second row of table 3) a floating point number ‘2.3’ is found.

As such, it can be seen that the data within table 2 (ie the database definition topic 303) can be thought of as pointer to the data.

To obtain this topic structure 304, the applications 308a, 308b, 308c had published the following messages over the network:

These contributions from each application 308a, 308b, 308c are compiled to form the database definition topic 303 and the database topic 305.

Working through the example of Application 3 308c publishing the information in Tables 6 above to the distributed database 304 and Application 4 connecting to, and receiving data from, Application 3, the steps taken in this embodiment are as follows:

1. Application 3 308c attaches to a publish/subscribe broker (which might be distributed);

2. Application 3 308c informs the broker that it intends to publish to the database definition topic 303 and the data table 305;

3. The broker stores this information for whoever may later request it;

Thus data from application 3 308c is now stored within the two topics: the database definition topic 303 and the database topic 305. The example now continues as to how a further application may request data from those two topics 303, 305;

4. Application 4 is turned on and wants to get all bit arrays (for example) in the network. That is, application 4 is specifying the data that it wants to obtain from the two topics 303, 305. A search of the database definition topic 303 will reveal all applications, and the locations thereof, that are providing bit arrays. The skilled person will appreciate that the database definition topic may be searched on a variety of other criteria;

5. Application 4 attaches to a broker;

6. The broker tells Application 4 to listen to everyone publishing to the database definition topic 303, namely Applications 1, 2, and 3 (308a, 308b, 308c);

7. The broker tells Application 4 the network address and port for these applications;

8. Application 4 connects to Applications 1, 2, and 3 (308a, 308b, 308c). This step may be thought as a discovery phase as Application 3 is looking data of interest.

9. Once Application 4 has connected to Applications 1, 2, and 3, Application 1, 2, and 3 send their definition table messages (first part of Tables 4-6, above) which specific the data within the data definition topic. Application 4, knowing the form of definition data tables messages (as it has an unchanging structure), can interpret this information (ie the sought data);

10. Application 4 searches the definition data tables for entries which have Bit Arrays;

11. Finding only one entry (ID 4), the table (first part of Tables 6) tells Application 4 that the entry in question is from Application 3 308c;

12. With this information, Application 4 approaches the broker to ask to attach to the data table (second part of Tables 6) of Application 3 308c;

13. The Broker responds, connecting Application 4 to Application 3 for sending of data table messages;

14. Application 3 then sends one or more data table messages to Application 4:
a. Each message is interpreted as a bit array, as that is the format information as obtained from the database definition topic 303;
b. Application 3 may send a one-off message (e.g. in response to a query for financial information of a customer) or multiple (e.g. continuous) messages (e.g. keeping a sensor reading up to date).

In alternative embodiments, the broker may store the entries of the database definition topic 303, so that only the application with the relevant data has to be queried. In such an embodiment, applications wishing to obtain data may be able to identify suitable database topics 305 by, in the discovery phase, querying the broker(s) rather than connecting directly to applications. However, embodiments in which it is the subscriber that discovers appropriate applications (which may be thought of as data components) as opposed to the broker because it is a complex process which is more convenient to cause subscribers to perform as they may well have a greater capability and/or domain knowledge.

In still further embodiments, no broker may be present and each application 308a, 308b, 308c may instead broadcast the data to the network 300 as a whole.

In the embodiments being described, the structure of the database definition topic 303 does not change—rows may be added or deleted, but the number of columns, heading of each column, and data format of each column is constant. The applications 308a, 308b, 308c always respond with the same message format, every time someone connects to them to query the database definition topic 303.

By contrast, the database topic 305 is published/updated regularly. Each application 308a, 308b, 308c separately emits a new version of it data table messages whenever new information is ready to be published. If an application subscribes to (for example) Application 3 308c, it will either wait for a new data table message, or in some publish/subscribe systems (like DDS—the “Data Distribution Service for real-time systems” Object Management Group standard), when a new application starts listening to Application 3 308c, Application 3 will resend the previous message to the new application.

The skilled person will appreciate that the separation between the topics 303, 305 facilitates the reduction of communication overheads once the applications know how to interpret database definition topic 303 messages. Provided that each application knows the format/structure of the database definition topic 303, no prior knowledge of the database topic 305 nor of the other applications, is needed for successful communication.

It is worth noting that, without the correct interpretation definitions, the second column in the database topic 305 (Tables 4-6) would not be correctly read by subscribing applications, and may appear to contain binary nonsense, depending on default settings.

The data definition topic 303 can have numerous columns in the table exposing more semantic data (e.g. rate of publishing, location, type of robot, etc.); any of this data can be queried. The skilled person will appreciate that the column content will depend on the purpose/usage of the network.

A query from a subscriber could seek data according to any available fields, for example all bit arrays (as for the example above). Subscribers could seek data with a more complex search criteria such as, for example, all haptic devices with 6 degrees of freedom, and an accuracy greater than 1 mm. As another example, subscribers may search for weather sensors on autonomous cars in the vicinity of Swindon.

The skilled person will appreciate that the use of predefined topics 303, 305 that hold separately a data schema (in database definition topic 303) and data (ie in database topic 305) on top of the publish/subscribe model provides various advantages. The benefits of the publish/subscribe model (i.e. underlying communication protocol abstraction, topology agnosticism, and publisher/subscriber agnosticism) are maintained, whilst removing, or at least ameliorating, the drawbacks of:
needing heavily-defined, rigid data structure defined by the user/developer (meaning that any changes to a message/data being sent will render it unreadable to everyone else in the system regardless how negligible of a change); and
adding extra semantic information (which may be useful for queries and discovery of data) with minimal communication overheads.

This leads it to the disclosed approach being an advantageous communications method for large systems of systems, e.g. the internet of things, large group robotic systems, fleets of autonomous cars, etc. Such systems tend to evolve over time (changing elements) and require a large amount of collaboration/communication between similar but not identical systems. The system could also be used by financial services companies or the likes to collate and manage distributed data.

Traditionally, a software update in a single robot could render a car manufacturing plant useless as other entities could no longer communicate with that robot. The disclosed approach therefore goes towards the idea of “scalable standardisation”; as long as the bare minimum and required data still exist in the table (or close enough) an application can add any data it wishes without disrupting communications.

As mentioned above, in prior art systems 900 communications within an application 908c are generally simpler than communications between separate, remote applications 908a, 908b, 908c which remote communication relies on network communication.

For the purposes of the following description, two remote applications 908a, 908b, 308a, 308b communicate with a third application 908c, 308c running on a local processing device.

Modules 910a, 910b, 910c, which are typically software but need not be so, within the local and remote applications 908a, 908b, 908c generally communicate within a given application 908a, 908b, and between different applications 908a, 908b, 908c, as shown in FIG. 9 which illustrates a prior art communication model 900.

The skilled person will appreciate that the “software modules” 910a, 910b, 910c, and any other software, can be implemented in hardware, firmware, or a combination of any of hardware, firmware and software, and that the term “software” is used herein for simplicity rather than to limit the implementation.

In the embodiments being described, a virtual proxy communications model 1000 is used. The method of the embodiment being described is also illustrated with reference to FIG. 12.

In the virtual proxy communications model 1000 of the embodiment being described, a simulated version 1002a, 1002b each remote application 308a, 308b is created within the local application 308c. The simulated versions are virtual proxies 1002a, 1002b are designed such that the local application 308c cannot distinguish if the virtual object 1002a, 1002b is local or remote, as indicated by the depiction of Application 3 308c with the proxies 1002a, 1002b of Applications 1 and 2 provided in FIG. 10B. In this embodiment, the virtual proxy communications model 1000 may be described as a virtual clone communications model 1000, where also a virtual proxy is then referred to as a virtual clone.

In the embodiment being described, each virtual proxy 1002a, 1002b exposes the same interfaces as if the cloned applications were local. However, the proxies 1002a, 1002b do not perform the functionality of the cloned applications 308a, 308b, but rather automatically maintain communications between the local application 308c and the remote applications 908a, 908b.

In the embodiment being described, each virtual proxy 1002a, 1002b stores the same data as stored by the application 308a, 308b it clones. If Application 1 308a comprises a temperature sensor, the virtual proxy 1002a stores the same temperature reading(s) (e.g. just the latest reading, just the latest 5 readings, or readings including time-stamped historical data) as Application 1 308a. The virtual proxy 1002a is arranged to know the frequency at which Application 1 308a updates its temperature data and communicated with Application 1 at an appropriate frequency so as to keep the information up to date.

The local application, Application 3 308c, can then make a direct, local, memory call to the relevant local memory portion where the virtual proxy 1002a stores the temperature reading(s), or any other suitable technique for accessing data locally, so as to obtain the data without needing to make any remote communications.

In response to the temperature reading (or separately), Application 3 308c may wish to instruct Application 1 308a to take an action. Application 3 308c therefore instructs the local proxy 1002a, which is a proxy for Application 1, using internal communication methods, and the virtual proxy 1002a relays the instruction, handling the remote communications and performing any necessary translations.

In this way, the developer of the local application 308c can avoid the use of communications protocols and translations for communications between Application 1 308a and Application 3 308c, as this is handled within the virtual proxy 1002a.

For example, a software module 310a may expose four floating point numbers and a callable function. The virtual proxy 1004a also will expose four floating point numbers and a callable function. The virtual proxy 1002 manages its own communications so that:
(i) the four floating points are kept up to date (within reason—update frequency may be set based on specific system details of any implementation) by maintaining communication with Application 1 308a; and
(ii) a function call from Application 3 308c calling on the callable function is converted into a remote procedure call, by the virtual proxy, so that the request is passed onto Application 1 308a for execution.

In the embodiments being described, the virtual proxies 1002a, 1002b are run asynchronously and in parallel to the local software objects 310c, which provide application 3 308c, so as to disguise their internal operations.

The embodiment being described uses an Observer model, where the virtual proxies 1002a,1002b should indistinguishable from software models running locally, such as module 310c, for their observers.

The skilled person will appreciate that an observer model is a design pattern, where application 3 308c reads data but can request changes of behaviour from other applications, such application 1 for example. However, application 3 308c (or any other application running an observer model) does not substantively affect behaviour of data, unless application 1 308a agrees to requests. To exemplify this observer model, reference is made to Graphical User Interfaces (GUI's), where the GUI simply displays data (ie the GUI is observing data that is sent to it).

The disconnect in the observer model makes it well suited for the virtual proxy and the application 308c (ie the host) may be thought as observing the proxy 1002a, 1002b. As the 2 way communications are more structured and limited to simple reading of data and requests of change of state.

Referring to the system 1000 shown in FIG. 10A, in the embodiment being described, Application 1 308a initialises and exposes a network interface, which can be used by anyone in the network. In alternative or additional embodiments, permissions may be checked and a password or the likes may be needed to access the network interface.

Once the network interface is exposed, Application 3 308c can make a virtual proxy 1002a of Application 1 308a. In this way, the network infrastructure behind the abstraction of the virtual proxy 1002a is masked.

Application 3 308c can achieve this by creating the necessary interface structures as defined by Application 1 308a. This may include reserving memory necessary for the proxy (i.e. the structure and data values required to create the virtual proxy 1002a, and potentially also processing capacity for translations etc.) that will be communicated from Application 1 308a to Application 3 308c.

In this embodiment, Application 3 308c also sets up the infrastructure for the virtual proxy 1002a to automatically handle network communications. Then, if Application 3 308c wishes to activate a camera of Application 1 308a, Application 3 308c interfaces with the virtual proxy 1002a as if there was no network distribution, and the virtual proxy 1002a relays the instruction to Application 1 308a.

The virtual proxy 1002a, 1002b is arranged to be able to send and receive any data that may be required in internal or external communications. This data can be sent in as many or as few exchanges as wished, and any suitable network infrastructure (e.g. TCP/IP or Shared Memory) may be used. Data received by the virtual proxy 1002a, 1002b is then translated into an internal form suitable for Application 3 308c, such that it is internally indistinguishable from local interfaces.

In the embodiment being described, the virtual proxies 1002a, 1002b are arranged to manage and hide/abstract multiple communication methods simultaneously. For example, communications that are required to be fast but not to assure receipt can be sent over one method (e.g. UDP over Wi-Fi), whereas slow, high-assurance data could be sent over a proprietary networking method, and analogue signals could be sent over copper wire; this complexity is hidden by the virtual proxy 1002a, 1002b.

In the embodiment being described, the virtual proxy 1002a, 1002b is created at initialisation, and destroyed at destruction; ie when there is a need to communicate with the remote application the virtual proxy 1002a, 1002b initialisation occurs and the virtual is formed and when there is no longer a need to communicate with the remote application the virtual proxy is advantageously destroyed to free up resources). Advantageously, memory usage is therefore not changed at run-time, which is beneficial for real-time applications as rearranging memory is generally a relatively complex and slow process, which may not be compatible with deterministic time constraints of real-time. The virtual proxy 1002a, 1002b alleviates this issue by separating out the communications into a static, predetermined object that can be verified and deployed. The skilled person will appreciate that because the communication logic and application logic are separated, then the communication logic can be verified separately. Such separate verification of the logics is a simpler task than verifying both logics at the same time. An additional advantage is that once the disconnected communication unit has been verified and validated, it can be used for different applications and maintain its verification.

The skilled person will appreciate that, in embodiments in which real-time operation is not a constraint, the creation and deletion of virtual proxies 1002a, 1002b may be more flexibly timed, and may occur during run-time.

The skilled person will appreciate that different applications (ie uses) of the embodiments of communication will have different constraints. Some applications (ie uses) may require data to be processed at a predetermined frequency, such as to allow a vehicle to control a traffic light, in real time, as that vehicle approaches the traffic light. However, in other applications (ie uses) so-called determinism may be a more useful criterion where an action must be performed within a predetermined time window, and should not be missed because the application (ie the process) is managing memory or the like.

In the embodiment being described, the virtual proxy 1002a, 1002b is created using a system similar to the distributed database definition topic 303 discussed above to define the interfaces.

In alternative or additional embodiments, Application 1 308a broadcasts its definition of its virtual proxy 1002a using another method, for Application 3 308c to read and interpret.

An alternative embodiment 1500 is shown in FIG. 11—in this embodiment, it is the local application, not the remote application, that provides a definition for the virtual proxy.

In the virtual proxy communications model 1500 of the embodiment of FIG. 11, a simulated version 1100 of a part of each remote application 308a, 308b is created within the local application 308c.

In this embodiment, the local application 308c has a template for the local virtual proxy 1100 and finds software modules 1310a, 1310b which meet the requirements of the template. In the embodiment shown a first software module 1310a is provided by one of the software modules 310a of the first application 308c and a second software module 1310a is provided by one of the software modules 310b of the second application 308b. The system 1500 therefore clones only the relevant parts of each of the first and second applications 308a,b. The system 1500 therefore creates the simulated version 1100 of a part of each remote application 308a, 308b (also referred to as the virtual proxy 1100 or simulator) within the local application 308c automatically, without requiring user input. The system 1500 can therefore provide its own simulator 1100, as opposed to relying on a third-party system interpreting data from the first system and developing a simulator of its choice, which might limit compatibility and/or communications.

The virtual proxy 1100 retains communications with both the first application 308a and the second application 308b; using any known communications protocol for these remote communications.

The skilled person will therefore appreciate that the virtual proxy 1100 is set up automatically (without user intervention) by the system 1500 to improve communications. A user can connect to the remote application 308a,b via the virtual proxy 1100.

In the embodiment being described, the local application 308c can communicate with the remote application 308a,b, and the remote application 308a,b can communicate with the local application 308c, via the virtual proxy 1100. The system 1500 can therefore provide automated inter-process communications irrespective or the presence or absence of a user. Further, one or more different communication methods can be used in both directions between the remote and local applications 308; communications do not have to be one-way.

The virtual proxy 1002a, 1002b, 1100 therefore may not be a clone of an entire remote device or application, but can instead clone a part of one or more remote devices or applications to form a virtual proxy 1100 which does not replicate the whole of any one remote device/application.

The skilled person will appreciate that the use of local virtual proxies 1002a, 1002b offers various advantages, including:
It creates a homogenous interface, agnostic to distribution.
   It is the typical for internal (internal to an application/piece of software) communications and external communications (ie external to an application/piece of software) to be different and the differences are typically there to handle the inherent complexities of network communications. However, these differences create work and complexity for developers, who have to cope with both interface types. Such complexity is especially apparent when and application's (piece of software) topology can be altered such that modules of the application can be moved between physical processing circuitries (ie physical machines or the like)
   As such, if there is one interface for both local and remote communications, as proposed in embodiments herein, the developer's job is simplified.
The enforced separation of functionality and communications enables easier verification and validation of each of the functionality and communications since both are separated and can be verified separately.
Timing issues can be hidden and managed automatically. To give one example, a camera may be arranged to update at irregular intervals, such as a security camera that only updates when movement is detected. An application may be provided that requires the images from the security camera, which application may be a face recognition software running at fixed rate, ie expecting an image to be input every minute. An advantage of embodiments as described herein is that separating the logic from communications, the application developer does not have to deal with checking they have the latest image, since it is inherent in the system that the local proxy will automatically update itself to obtain the latest data (here, the latest image).
It allows for complex and multiple protocol communications to be hidden, making it even simpler for developers who are using multiple communication mechanisms (hardware and software) that can be running at different rates.

FIG. 12 shows a flow chart 1200 for a method of creating a virtual proxy. Initially, a local application 308c determines remote applications (eg 308a, 308b) with which it desires to communicate (step 1202).

Once the identity of the remote applications has been determined, the necessary communication protocols with which to communicate with those remote applications 308a, 308b are determined. This determination can be through a discovery process—step 1204.

Once the communications have been determined, the method, in step 1206, starts to create the virtual proxy 1002a, 1002b. Initially, the method creates a virtual proxy of the internal interface; ie that which allows the local application 308a to communicate.

Subsequent to the creation of the creation of the internal interface, the method sets up an external interface, in step 1208, to allow the virtual proxy 1002a, 1002b, to communicate with the application of which it is a proxy.

In step 1210 proxies for the internal communication frameworks are created.

In step 1212 communications with the virtual proxy 308a, 308b are started.

In step 1214 incoming data is received at the virtual proxy 308a, 308b and the virtual proxy 308a, 308b now functions as described elsewhere.

FIG. 13 illustrates a combined use of the virtual proxy and distributed database approaches.

In an environment 1300, a vehicle 1302 is driving along a road 1304. The vehicle 1302 is an emergency services vehicle.

The vehicle 1302 is approaching some traffic controls, in this case traffic lights 1306.

The traffic controls 1306 comprise a control device 1310 running a first application 308a.

The vehicle 1302 comprises a vehicle device 1308 running a third application 308c.

As the vehicle 1302 approaches the traffic controls 1306, the vehicle device 1308 comes within communication range of the control device 1310.

The control device 1310 broadcasts a database definition topic 303 and a database topic 305 for receipt by the third application 308c on the vehicle device 1308.

The third application queries the database definition topic 303 to discover how and where to find information relating to creating a virtual proxy 1002a of the first application 308a.

The database definition topic 303 tells the third application 308c where in the database topic 305 this information can be found, and what format the data are in, so that the third application 308c can locate and read the required data.

The third application 308c running on the vehicle device 1308 retrieves the required data from the identified location within the database topic 305 and interprets it using the format information provided.

Using the retrieved data, the third application creates a virtual proxy 1002a of the (remote) first application 308a within the vehicle device 1308 so that the virtual proxy 1002a is running locally.

The third application 308c then interfaces with the virtual proxy 1002a so as to control the traffic lights 1306.

When the third application 38c instructs the virtual proxy 1002a to stop traffic flow (e.g. for safety following an accident), the virtual proxy 1002a relays that instruction to the first application 308a running on the traffic controls 1306, and the traffic controls 1306 implement the instruction.

The control device 1310 then publishes updated signal status information to the database topic 305. The virtual proxy 1002a maintains and updates a record of control device status.

From the point of view of a user of the vehicle device 1308, the virtual proxy 1002a allows the traffic controls 1306 to be controlled as if they were a local device or process, with the remote communications being handles “behind the scenes” by the virtual proxy 1002a.

In another embodiment, the vehicle device 1308 has a template for a virtual proxy of a traffic light with a temperature sensor. In the environment of the vehicle 1302, most of the traffic lights 1306 have an integral temperature sensor and so a clone of the control device 1310 allows the vehicle device 1308 to obtain a temperature reading.

However, some traffic lights 1306 do not have a temperature sensor. In such cases, the vehicle device 1308 would then search for an additional networked device with a temperature sensor in the vicinity of the traffic light, and clone a part of that device into the local virtual proxy, so completing its proxy of a traffic light with temperature sensor. In this way, the local virtual proxy can adapt to deficiencies or differences in devices with which it communicates, and complete the proxy using a hybrid between available devices.

As a further example of how embodiments may be arranged, FIG. 14 shows how communications may be passed between applications. It can be seen that the Figure shows application 1 (308a), application 2 (308b), a virtual proxy (1002a) having both external and internal communications, and application 3 (308c) which, as before, is seen to host the virtual proxy 1002a. The virtual proxy has two lines underneath, the leftmost line representing a model of at least a portion of application 1, and the rightmost line representing a model of a least a portion of application 2.

The Figure shows how application 3 may communicate with and read data from the applications 1 and 2 in the set up of FIG. 10a where there are virtual proxies 1002a, 1002b that have been created to represent application 1 308a, and application 2 308b respectively.

Looking at application 3, it can be seen that the first communication that it makes is to read translated data from application 2, twice. However, it will be seen that the virtual proxy (the leftmost line thereof) has already subscribed to application 2 and as such, there is already a copy of the data of application 2 within the virtual proxy. As such, the virtual proxy can simply serve up the requested data to application 3 when the request is made. Here it is noted that the arrows are pointing in an upwardly direction to show that the application is reading a past event (ie data that was already in place when application 3 makes the request).

After application 3 has obtained the data from application 2, via the virtual proxy, application 3 determines that there is a need to try and cause application 1 to change state, recalling that in an observer model, application makes a request rather than controls. As such, application 3 sends a request to the virtual proxy (see the rightmost line of the virtual proxy representing the first application). The virtual proxy translates the request and send the request to the first application. Application 1 can then respond to the request as it sees fit.

Further, application 3 subsequently is shown to make a further six reads of data from application 2, via the virtual proxy. Again, it will be seen that the virtual proxy (leftmost line thereof) has already updated itself with data from application 2 and the virtual proxy is able to provide data to serve the request from application 3.

1-17. (canceled)

18. A computer-implemented method of operating a remote application, the method comprising,
communicating with the remote application across a connection thereto;
receiving information from the remote application across the connection,
automatically creating, in a local processing circuitry running a local application, a proxy of at least a portion of that remote application using the received information, wherein the proxy is a simulated version of the at least a portion of the remote application comprising a local copy of data stored by the portion of the remote application and proxy functions corresponding to callable functions of the portion of the remote application;
causing the proxy to communicate with the remote application so as to keep the local copy of the data held by the portion of the remote application up to date, such that the local application can make a local memory call to obtain that data; and
causing the proxy to relay any local calls on the proxy functions made by the local application to the corresponding callable function of the portion of the remote application,
wherein the proxy is arranged to handle remote communications between the local processing circuitry and the remote application such that the local application can interact with the portion of the remote application using local communication.

19. A computer-implemented method according to claim 18 wherein the proxy is arranged to be a copy of the entire remote application that it simulates.

20. A computer-implemented method according to claim 18 wherein the proxy is arranged to include portions of different applications to provide a proxy which is an aggregate of the two or more applications that it models.

21. A computer-implemented method according to claim 20 wherein the applications that are being modelled by the proxy are on different processing circuitries.

22. A computer-implemented method according to claim 18 wherein communications between the local and remote applications are governed by a method of allowing a first application and a second application to communicate within a publish/subscribe architecture, the first and second applications each being aware of a structure of a database definition topic, the method comprising:
providing two topics to which the applications can subscribe, the database definition topic and a database topic;
structuring the database definition topic such that data held therewithin defines the structure of data within the database topic;
causing the first application to publish a definition entry in the database definition topic, the definition entry including a data format definition and a data location, and at least one data entry to the database topic, the entry to the database topic having the defined data format and being placed at the defined location;
causing the second application to query the database definition topic to obtain the defined format and location of data sought within the database topic;
causing the second application to query the database topic to obtain the sought data as specified within the definition entry of the database definition topic; and
causing the second application to interpret the sought data using the data format definition;
wherein the local application and remote application are each one of the first application and the second application.

23. A system comprising at least one processor, wherein the processor is programmed to operate a remote application, by being arranged to perform the following:
communicate with the remote application across a connection thereto;
receive information from the remote application across the connection,
automatically create, in a local processing circuitry running a local application, a proxy of at least a portion of that remote application using the received information, wherein the proxy is a simulated version of the at least a portion of the remote application comprising a local copy of data stored by the portion of the remote application and proxy functions corresponding to callable functions of the portion of the remote application;
cause the proxy to communicate with the remote application so as to keep the local copy of the data held by the portion of the remote application up to date, such that the local application can make a local memory call to obtain that data; and
cause the proxy to relay any local calls on the proxy functions made by the local application to the corresponding callable function of the portion of the remote application,
wherein the proxy is arranged to handle remote communications between the local processing circuitry and the remote application such that the local application can interact with the portion of the remote application using local communication.

24. A machine readable data carrier carrying instructions which when read by a processor cause that processor to perform the method of claim 18.

25. (canceled)
